(19) United States
(12) Patent Application Publication
(10) Pub. No.: US 2012/0044110 A1
(43) Pub. Date: Feb. 23, 2012

(54) Advanced positioning system

(76) Inventor: Miha Abrahamsberg, Ribnica (SI)

(21) Appl. No.: 13/159,420

(22) Filed: Jun. 14, 2011

Related U.S. Application Data
(60) Provisional application No. 61/375,046, filed on Aug. 19, 2010.

(51) Int. Cl. G01S 5/02

(52) U.S. Cl. 342/464; 342/450

(57) ABSTRACT

The subject of the invention is a system or a method of determining the position of the radio signal receiver with respect to the radio signal transmission from a single moving transmitter with one or more antennas or from one static transmitter with one or more static or moving antennas. In order to determine the signal receiver position, three or more signals from different positions or points (antennas) of a single signal transmitter are needed. The transmitted signals include information on latitude, longitude and altitude of individual antennas, and the exact time of signal transmission with respect to the time recorded on the transmitter itself. The signal receiver uses the abovementioned information to calculate its own position. The invention eliminates and resolves the limitation of the current state of technique with regard to the use of several transmitters (satellites) and time synchronization between individual transmitters (satellites), since the position can also be determined with the use of a single transmitter or satellite, and there is no need for time synchronization between individual transmitters.

I would like to claim the benefit of the provisional application No. U.S. 61/375,046, filling date Aug. 19, 2010.

Subject of the invention is a system of devices, where the first device functions as the transmitter post (transmitter), which transmits one or several radio signals and the other device functions as the receiver, which receives the transmitted signals and the consecutive manner of determining geographical position. The radio signals are transmitted from the transmitter with one or more antennas, each of which has a different geographical position (x, y, z). The receiver receives the signals and from the received signal information calculates its own geographical position (navigation). The transmitter can be located on the Earth's surface or in the orbit (on satellite).

In order to determine the signal receiver position, three or more signals from different positions or points of a single signal transmitter are needed. Each transmitted signal includes information on its own latitude (X), longitude (Y) and altitude (Z), and the exact time of signal transmission with respect to the time recorded on the transmitter itself.

The invention relates to the moving signal transmitter (i) which transmits information on the latitude, longitude and latitude of antennas which are positioned on it including the time of signal transmission, and to the signal receiver which receives the abovementioned information and uses it to calculate data on its own latitude, longitude and altitude, and the static transmitter (ii), which simultaneously transmits signals from three or more antennas with data on latitude, longitude and altitude of the antennas including the time of signal transmission with regard to the transmitter and the signal receiver, which receives the abovementioned data and uses it to calculate data on its own latitude, longitude and altitude, and the system of static and moving transmitters (iii), which simultaneously transmit signals from one or more antennas with data on latitude, longitude and altitude of the antennas including the time of signal transmission with regard to the transmitter and the signal receiver, which receives the abovementioned data and uses it to calculate data on its own latitude, longitude and altitude.

For positioning, the recognized global positioning system (GPS) uses more than one transmitter (satellite) per receiver, and a complex system of time synchronization between transmitters/satellites (atomic clock synchronization). This is incomparably more expensive than the invention concerned. The invention solves the problem of current technology concerning the use of several transmitters (satellites) and time synchronization between individual transmitters (satellites).

A detailed description with mathematical derivations for the operation of the invention is given below.

Two signals transmitted from different positions or points incorporate the following information:

Transmitter position in point A=A(x₁, y₁, z₁) and time of signal transmission t₁.

Transmitter position in point B=B(x₂, y₂, z₂) and time of signal transmission t₂.

The signal receiver is located at an unknown point T=T(X, Y, Z) and receives information on point A, time of transmission t₁ and time of reception t₃, and information on point B, time of transmission t₂ and time of reception t₄.

The distance between the receiver and the first signal transmission point is AT, and the distance between the receiver and the second signal transmission point is BT.

The difference dt between the time of reception and the time of transmission is multiplied by the speed of signal travel (speed of light/electromagnetic radiation), thus obtaining d, the difference between BT−AT distance.

The above data can be used to describe a group of points in a three-dimensional space where the receiver might be located:

A(x₁, y₁, z₁)

B(x₂, y₂, z₂)

T(X, Y, Z)

t₁, t₂, t₃ in t₄; time of transmission/reception (see above)

V=speed of light (electromagnetic radiation)

dt=(t₄−t₃)−(t₂−t₁)

d=BT−AT=dt*V

AT²=r²

BT²=(r+d)²

First, the distances AT and BT are expressed with an equation to calculate the distance between two points in a three-dimensional coordinate system:

AT²=r²=(X−x₁)²+(Y−y₁)²+(Z−z₁)² [1]

BT²=(r+d)²=(X−x₂)²+(Y−y₂)²+(Z−z₂)² [2]

r is expressed from [2]:

r²=(X−x₂)²+(Y−y₂)²+(Z−z₂)²−2*d*[(X−x₂)²+(Y−y₂)²+(Z−z₂)²]^{1/2}+d² [3]

Equate [1] and [3]:

(X−x₁)²+(Y−y₁)²+(Z−z₁)²=(X−x₂)²+(Y−y₂)²+(Z−z₂)²−2*d*[(X−x₂)²+(Y−y₂)²+(Z−z₂)²]^{1/2}+d²

Simplify to obtain:

[(x₁−x₂)*X+(y₁−y₂)*Y+(z₁−z₂)*Z−u]²=d²*[(X−x₂)²+(Y−y₂)²+(Z−z₂)²] [4]

Where u equals:

u=(x₁²+y₁²+z₁²−x₂²−y₂²−z₂²−d²)/2

The entire equation [4] is simplified, thus obtaining the final quadratic equation with three unknowns (X, Y Z):

K*X²+L*Y²+M*Z²+N*XY+Q*XZ+P*YZ+R*X+S*Y+T*Z+V=0

K, L, M, N, Q, P, R, S, T and V coefficients are the following:

K=(x₁−x₂)²−d²

L=(y₁−y₂)²−d²

M=(z₁−z₂)²−d²

N=2*(x₁−x₂)*(y₁−y₂)

Q=2*(x₁−x₂)*(z₁−z₂)

P=2*(y₁−y₂)*(z₁−z₂)

R=2*[x₂ d²−u*(x₁−x₂)]

S=2*[y₂ d²−u*(y₁−y₂)]

T=2*[z₂ d²−u*(z₁−z₂)]

V=u²−d²*(x₂²+y₂²+z₂²)

One equation [5] is composed from a pair of signals transmitted from one transmitter. In the case of one transmitter transmitting three signals from three different points and one receiver receiving them, a three-equation system [5] can be written for the receiver; when the transmitter transmits the signal from four different points and one receiver receives them, a six-equation system [5] can be written, and so on:
Xp=number of signal transmissions from different points of the same transmitter
Yp=number of different equations [5] that can be written for a single receiver
Yp=[Xp*(Xp−1)]/2

The obtained equation system is written as (in respect of the number of transmitted signals from a single transmitter):

$${K}_{1} * {X}^{2} + {L}_{1} * {Y}^{2} + {M}_{1} * {Z}^{2} + {N}_{1} * XY + {Q}_{1} * XZ + {P}_{1} * YZ + {R}_{1} * X + {S}_{1} * Y + {T}_{1} * Z + {V}_{1} = 0 \\ {K}_{2} * {X}^{2} + {L}_{2} * {Y}^{2} + {M}_{2} * {Z}^{2} + {N}_{2} * XY + {Q}_{2} * XZ + {P}_{2} * YZ + {R}_{2} * X + {S}_{2} * Y + {T}_{2} * Z + {V}_{2} = 0 \\ ⋮ \\ {K}_{N} * {X}^{2} + {L}_{N} * {Y}^{2} + {M}_{N} * {Z}^{2} + {N}_{N} * XY + {Q}_{N} * XZ + {P}_{N} * YZ + {R}_{N} * X + {S}_{N} * Y + {T}_{N} * Z + {V}_{N} = 0 \qquad [ 6 ]$$

Due to its complexity, the equation system [6] is solved by using methods for solving non-homogenous systems of non-linear equations analytically with the following procedures:
Gauss elimination,
Cramer's rule,
etc.

When the system can no longer be managed, numerical solving is used.

By solving the equation system, the point is obtained where the receiver T=T(X, Y, Z) is located, and thereby the signal receiver position (latitude, longitude and altitude).

1. The system of devices or the method of determining the position (navigation) of the radio signal receiver with respect to the signal transmission from a single moving transmitter post (transmitter) with one or more antennas which transmit signals. The system enables the calculation of the geographical position of the signal receiver from three or more signals different positions, whereby each transmitted signal includes information on the latitude (X), longitude (Y) and altitude (Z) of the antennas, and the exact time of signal transmission with respect to the time recorded on the transmitter itself.

2. The system of devices or the method of determining the position (navigation) of the radio signal receiver with respect to the signal transmission from the static transmitter post (transmitter) which simultaneously transmits signals from three or more antennas. The system enables the calculation of the position of the signal receiver from three or more signals received from the transmitter, whereby the transmitted signals include information on the latitude (X), longitude (Y) and altitude (Z) of the antennas, and the exact time of signal transmission with respect to the time recorded on the transmitter itself.

3. The system of devices or the method of determining the position (navigation) of the radio signal receiver with respect to the signal transmission from several connected static or moving transmitter posts (transmitters) which transmit signals from one or more antennas. The system enables the calculation of the position of the signal receiver from three or more signals received from the transmitters, whereby the transmitted signals include information on the latitude (X), longitude (Y) and altitude (Z) of the antennas, and the exact time of signal transmission with respect to the time recorded on the transmitters themselves.
